(19) United States
(12) Patent Application Publication
(10) Pub. No.: US 2004/0074893 A1
(43) Pub. Date: Apr. 22, 2004

(54) Ceramic hotplate consisting of a glass ceramic plate

(76) Inventors: Karsten Wermbter, Budenheim (DE); Holger Köbrich, Fl?ouml;rsheim (DE)

Correspondence Address: Douglas H Pauley, Pauley Petersen & Erickson, Suite 365, 2800 West Higgins Road, Hoffman Estates, IL, 60195, US

(21) Appl. No.: 10/471,130

(22) PCT Filed: Mar. 5, 2002
(86) PCT No.: PCT/EP02/02401

(30) Foreign Application Priority Data
Mar. 6, 2001 (DE) 101 11 734.5

(51) Int. Cl. H05B 3/68

(52) U.S. Cl. 219/465.1

(57) ABSTRACT

The invention relates to a ceramic hot-plate with a glass ceramic plate which includes heating elements, which are separated by an insulating layer, for direct heating on the lower side thereof. The cooking area is sub-divided into at least one inner and one outer area which include individual heating elements for each partial area. Said heating elements can be switched or adjusted with regard to the output thereof by means of a control device according to temperature values detected by temperature sensors associated with the partial areas. Concentrically arranged conductor strips enable the hot-plate to be constructed easily, the design thereof ensuring that the surface thereof is used in an optimum manner and providing a high degree of heating efficiency by virtue of the homogeneous manner in which the partial areas are heated.

The invention relates to a ceramic cooktop with a glass-ceramic plate, which has heating elements separated by an insulating layer on its underside for direct heating, wherein the cooking zone is divided into at least one inner and one outer partial zone, containing individual heating elements in the partial zones, which can be switched or whose output can be regulated by a control device as a function of the temperature values detected by temperature sensor assigned to the partial zone sensors.

Such a ceramic cooktop is known from DE 41 30 337 A1. By means of the inner and outer partial zones it is possible to better match the heat output to the heat absorption in the areas of the cooking zone occurring during cooking. In this case the partial zones have a heat conductor, which is applied in a meander shape and which is conducted in the same way, in whose vicinity a sensor track for temperature detection extends. In this embodiment the heat conductor and the sensor tracks are applied to an insulating layer, which covers the entire cooking zone.

The meander-like guidance of the heat conductors and sensor tracks of this known ceramic cooktop make the production of the cooktop more difficult and expensive.

As shown in DE 195 10 989 A1, a ceramic cooktop has the same disadvantages if the heating elements are oriented in a ray shape toward the center of the cooking zone and extend over sector-shaped partial zones.

### CONFIRMATION COPY

The design and attachment of the heating elements is also difficult when concentric, circular strip conductors are attached to the underside of the glass-ceramic plate and extend over almost 360° of the circumference of the partial zones. The glass-ceramic plate forms parallel circuits of a multitude of temperature-dependent, differential resistors between two strip conductors, as shown in DE 40 22 846 A1.

The multitude of resistors can also be realized by means of many strip-shaped conductor tracks whose ends are connected in parallel, as shown in EP 0 315 079 B1 (DE 38 84 569 T2). However, no partial zones, which can be individually controlled and regulated, are formed with this design of the cooktop.

It is the object of the invention to create a ceramic cooktop of the type mentioned at the outset, wherein a simple clear design of the heating elements makes their attachment easier and leads to an even heating of the divided partial zones with the associated temperature detection.

In accordance with the invention this object is attained in that the inner partial zone and the outer partial zones are formed by strip conductors, which are arranged concentrically with each other in a circular shape and leave free only one connecting sector extending into the center of the cooking zone, that in the connecting sector the strip conductors are switched in series by means of connecting elements, that the start of the innermost strip conductor and the end of the outermost strip conductor, as well as a connecting element providing the division of the individual partial zone heating elements, can be controlled by means of connectors, that the insulating layer is arranged at least underneath the strip conductors, and that a temperature sensor is assigned to at least the inner partial zone, and several temperature sensors are assigned distributed over the circumference of the outer partial zone, or that the inner partial zone and the outer partial zone are formed of two circular surface heating elements, which are arranged concentrically to each other, which leave only one connecting sector free, which extends to the center of the cooking zone, that by means of conductors in the connecting sector the two ends of the surface heating elements are connected together, and the starts of the two surface heating elements are individually connected, that the insulating layer is arranged at least under the surface heating elements, and that one temperature sensor is assigned to the inner partial zone and several temperature sensors are assigned, distributed over the circumference, to the outer partial zone.

In every case the strip conductors or the surface heating elements, together with the identically embodied insulating layers, constitute elements which can easily produced and leave areas free, in which temperature sensors can be attached directly to the underside of the glass-ceramic plate. The heating elements extend over the largest portion of the surfaces of the assigned partial zones and assure an optimal and even heating of these partial areas, which leads to a high degree of efficiency of the cooktop, since in addition the temperatures in the partial areas can be detected independently of each other in a simple way and can be used for switching and regulating the heat output. But the temperature sensors can also be applied to thin insulation layers covering the glass-ceramic plate outside the heating elements. If the temperature sensors are placed into insulating protective sheaths, they can also be attached to the heating elements.

In accordance with an embodiment, the connecting sector can be kept narrow by leading the connectors in the connecting sector past the outer partial zone. More space remains outside of the cooking zone for the connectors and connecting lines.

The temperature in the inner partial zone of the cooking zone is monitored in that the temperature sensor in the center of the cooking zone is embodied as a rod sensor or point sensor, and its connector is conducted via the connecting sector past the cooking zone.

In accordance with an embodiment it is provided for the heating elements, that the strip conductors are made of NiCr, NiAl or cermet alloys and are applied by thermal injection, while heating foils, NiCr, NiAl or cermet layers are used a surface heating elements, which are applied to the insulating layers.

The strip conductors and the surface heating elements can also be applied in the form of silver-containing webs or layers by means of screen printing. In addition, they can be applied by means of carbon pastes.

The invention will be explained in greater detail by means of exemplary embodiments represented in the drawings. Shown are in:

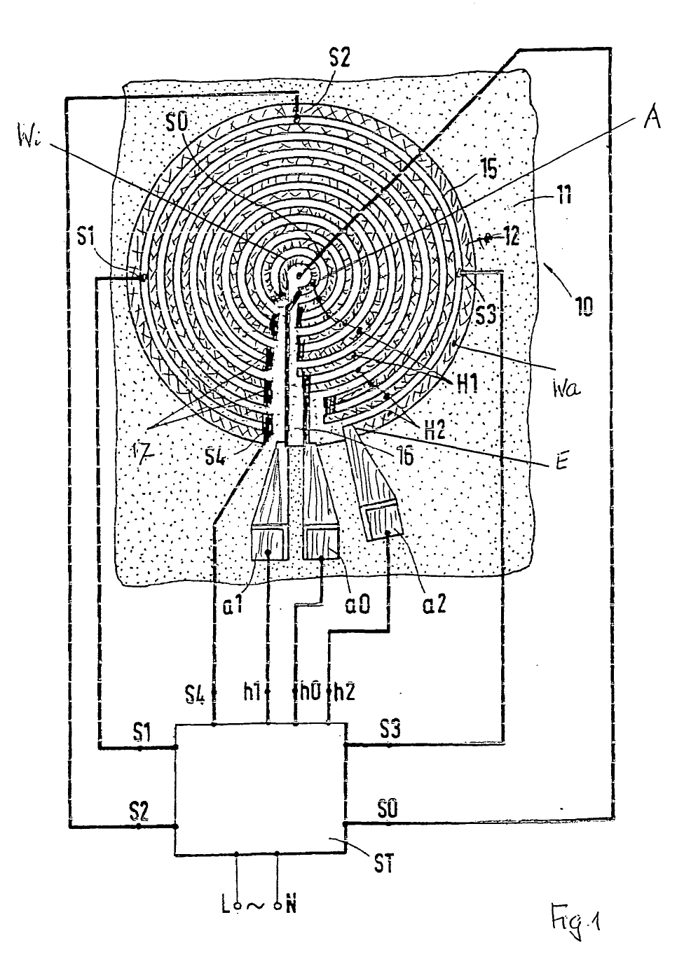

FIG. 1, a ceramic cooktop with inner and outer partial zones and strip conductors as heating elements, and

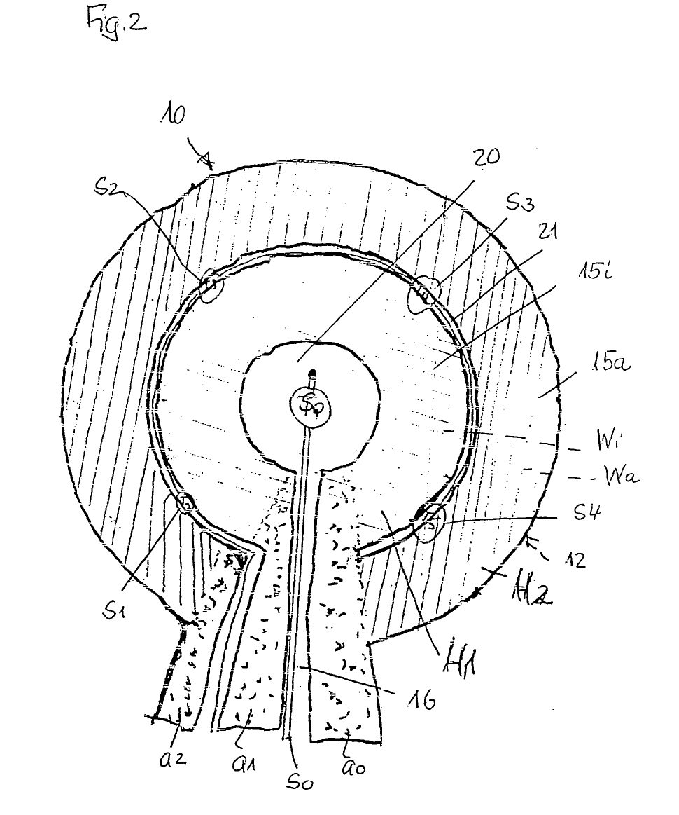

FIG. 2, a ceramic cooktop with inner and outer partial zones and surface heating elements as heating elements.

A view on the underside 11 of a glass ceramic plate 10 is represented in connection with the exemplary embodiment in FIG. 1. On its top, a circular cooking zone is distinguished in a known manner. Several circularly shaped strip conductors 15 have been applied to the underside of the glass-ceramic plate 10 on identically extending partial insulation layers 12 with identical surfaces. These strip conductors 15 extend over nearly 360° of the circumference of the cooking zone and only leave a narrow connecting sector 16 open, which extends to the center of the cooking zone. The insulating layers have a high electrical insulating resistance, i.e. a high electrical strength. They are embodied as thin insulated conductors with a low heat transfer resistance.

The strip conductors 17 are connected in series by means of connecting elements 17 in the area of the connecting sector 16, so that a heating coil with an alternating direction of rotation of the windings is created.

A connector aO is conducted to the start A of the strip conductor 15 in the connecting sector 16. A connector al is connected with a connecting element 17 in the connecting sector 16, so that the heating coil is divided into a heating element H1 and a heating element H2. These heating elements H1 and H2 are assigned to an inner partial zone Wi and an outer partial zone Wa.

The connector a2 is connected to the end E of the outermost strip conductor 15, so that the two heating elements H1 and H2 can be controlled independently of each other and their heating output is controllable. For this purpose a control device ST, which is connected to the line voltage, is provided, to which the connectors a0, a1 and a2 have been connected. The temperatures of the areas of the glass-ceramic plate 10 detected by the temperature sensors S0, S1, S2, S3 and S4 are provided as control and/or regulating values to the control device ST via the connectors S0, S1, S2, S3 and S4. In the center of the inner partial zone Wi, i.e. within the strip conductor 15, the temperature sensor S0 is directly connected with the underside 11 of the glass-ceramic plate 10 and directly detects the temperature of the glass-ceramic plate 10 at the connection point, without being inhibited by an insulating layer 12. If the temperature sensor is metallic, a thin insulating layer is provided outside of the heating elements for preventing short circuits.

The start A, the end E, as well as the tapping of the heating coil, lead to connectors located outside of the cooking zone, where they find sufficient space. Therefore the heating lines h0, h1 and h2 from the control device ST can be easily connected with the contacts a0, a1 and a2.

As FIG. 1 shows, the connecting sector 16 can be kept narrow, so that the circular strip conductors 15, which are arranged concentrically in relation to each other, can extend over a maximum portion of the circumference and can cover a large surface of the cook zone. This results in even heating of the partial zones Wi and Wa with good efficiency.

The partial insulating layers 12 can be attached in the same arrangement with the same surface on the underside 11 of the glass-ceramic plate 10, so that outside of the strip conductors 15 the underside 11 of the glass-ceramic plate 10 is accessible for the direct connection with the temperature sensors S0, S1, S2, S3 and S4, and so that the temperature sensors can perform the temperature measurement without hindrance by an insulating layer 12. As mentioned, these areas of the underside of the glass-ceramic plate 10 can also be covered by thinner insulating layers when metallic temperature sensors are employed.

In the exemplary embodiment in FIG. 2, a ring-shaped heating foil 15i constitutes the heating element H1 assigned to the inner partial zone Wi, and the ring-shaped heating foil 15a is the outer partial zone Wa. The contacts a0, a1 and a2 in the connecting sector 16 connect the heating elements HI and H2 in series in a counterclockwise direction. An insulation-free space 21 is created between the two heating foils 15i and 15a for the direct attachment of the temperature sensors S1, S2, S3 and S4 on the underside 11 of the glass-ceramic plate 10. The heating foil 15i has a centered recess 20, in which a temperature sensor S0, embodied as a rod sensor or point sensor, is arranged and its connector is conducted out of the cooking zone via the connecting sector 16, as well as the contacts a0, a1 and a2, and are in contact with a control device ST, the same as in the exemplary embodiment in FIG. 1. Thus, the two partial zones Wi and Wa of the cooking zone can be switched, and/or their heat output can be regulated, as a function of the associated temperatures.

In the exemplary embodiment in FIG. 2, the heating foils 15i and 15a also occupy the by far largest portion of the cooking zone, so that the partial zones Wi and Wa can be evenly heated as a function of the temperatures detected via the temperature sensors S0, or S1, S2, S3 and S4. In this connection the temperature sensors S1 to S4 assure that temperature variations over the circumference of the cooking zone edge can be detected in the outer partial zone Wa and taken into consideration.

On one side of the connecting sector 16, the contact a0 connects the two heating foils 15i and 15a as a tap for dividing the heating element into the partial heating elements H1 and H2.

The structure of the cooking zone with the two heating zones 15i and 15a is simple and can be easily attached.

Instead of in the form of heating foils, the surface heating elements can also be attached in a way similar to that of the strip conductors 15 in FIG. 1, for which NiCr or NiAl alloys, cermets, silver-containing layers or applications made of carbon pastes are used.

1. A ceramic cooktop with a glass-ceramic plate, which has heating elements separated by an insulating layer on its underside for direct heating, wherein the cooking zone is divided into at least one inner and one outer partial zone, containing individual heating elements in the partial zones, which can be switched or whose output can be regulated by a control device as a function of the temperature values detected by temperature sensor assigned to the partial zone sensors, characterized in that
the inner partial zone (Wi) and the outer partial zones (Wa) are formed by strip conductors (15), which are arranged concentrically with each other in a circular shape and leave free only one connecting sector (16) extending into the center of the cooking zone,
in the connecting sector (16) the strip conductors (15) are switched in series by means of connecting elements (17),
the start (A) of the innermost strip conductor (15) and the end (E) of the outermost strip conductor (15), as well as a connecting element (17) providing the division of the individual partial zone heating elements (H1, H2), can be controlled by means of connectors (a1, a2 and ao0),
the insulating layer (12) is arranged at least underneath the strip conductors (15), and
a temperature sensor (S0) is assigned to the inner partial zone (Wi), and several temperature sensors (S1, S2, S3, S4) are assigned distributed over the circumference of the outer partial zone (Wa).

2. A ceramic cooktop with a glass-ceramic plate, which has heating elements separated by an insulating layer on its underside for direct heating, wherein the cooking zone is divided into at least one inner and one outer partial zone, containing individual heating elements in the partial zones, which can be switched or whose output can be regulated by a control device as a function of the temperature values detected by temperature sensor assigned to the partial zone sensors, characterized in that
the inner partial zone (Wi) and the outer partial zones (Wa) are formed by two surface heating elements (15.1, 15.2), which are arranged concentrically with each other in a circular shape and leave free only one connecting sector (16) extending into the center of the cooking zone,
in the connecting sector (16) the two ends of the surface heating elements (15.1, 15.2) are connected together, and the starts of the two surface heating elements (15.1, 15.2) are individually connected by means of connecting elements (a0, a1, a2),
the insulating layer (12) is arranged at least under the surface heating elements (15.1, 15.2), and
one temperature sensor (S0) is assigned to the inner partial zone (Wi), and several temperature sensors (S1, S2, S3, S4) are assigned, distributed over the circumference, to the outer partial zone (Wa).

3. The ceramic cooktop in accordance with claim 1 or 2, characterized in that
the connectors (a0, a1, a2) in the connecting sector (16) extend past the outer partial zone (Wa).

4. The ceramic cooktop in accordance with one of claims 1 to 3, characterized in that
the temperature sensor (S0) in the center of the inner partial zone (Wi) is embodied as a rod sensor or point sensor and its connector is extended past the cooking zone via the connecting sector (16).

5. The ceramic cooktop in accordance with claim 1, characterized in that
the strip conductors (15) consist of NiCr, NiAl alloys or cermets and are applied by a thermal injection process.

6. The ceramic cooktop in accordance with claim 2, characterized in that
heating foils, NiCr, NiAl or cermet-containing layers are embodied as surface heating elements (15.1, 15.2) and are applied to partial insulating layers of identical surface.

7. The ceramic cooktop in accordance with one of claims 1 to 6, characterized in that
the strip conductors (15) or the surface heating elements (15.1, 15.2) consist of silver-containing webs or layers, which have been applied to the underside of the glass-ceramic plate (10) by means of screen printing, or consist of carbon pastes.

8. The ceramic cooktop in accordance with one of claims 1 to 7, characterized in that
the temperature sensors (S0, S1, S2, S3, S4) have been directly applied to the underside of the glass-ceramic plate (10) outside of the strip conductors (15) or the surface heating elements (15.1, 15.2).

9. The ceramic cooktop in accordance with one of claims 1 to 7, characterized in that
the temperature sensors (S0, S1, S2, S3, S4) are arranged outside of the strip conductors (15) or the surface heating elements ( 15.1, 15.2), wherein these areas of the glass-ceramic plate (10) are covered with thin insulating layers.

10. The ceramic cooktop in accordance with one of claims 1 to 7, characterized in that
the temperature sensors (S0, S1, S2, S3, S4) are housed in protective foils and have been attached directly to the lower conductors (15) or the surface heating elements (15.1, 15.2).
